(19) United States
(12) Patent Application Publication
(10) Pub. No.: US 2006/0242319 A1
(43) Pub. Date: Oct. 26, 2006

(54) Service Differentiated Downlink Scheduling in Wireless Packet Data Systems

(75) Inventors: Aimin Sang, Plainsboro, NJ (US); Xiaodong Wang, New York, NY (US); Mohammad Madihian, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/276,379

(22) Filed: Feb. 27, 2006

Related U.S. Application Data
(60) Provisional application No. 60/674,614, filed on Apr. 25, 2005.

(51) Int. Cl. G06F 15/173

(52) U.S. Cl. 709/240

(57) ABSTRACT

A base station design for a wireless communication system is disclosed with a hierarchical scheduler for packet data services which is advantageously both traffic-aware and channel-dependent in a manner which enhances the users' perception of network performance. In one embodiment, a cross-layer hierarchical scheduler is disclosed which further comprises an intra-user scheduler and an inter-user scheduler.

### CROSS-REFERENCE TO RELATED APPLICATIONS

This application claims the benefit of U.S. Provisional Application No. 60/674,614, entitled “TCP-DIFFERENTIATED DOWNLINK SCHEDULING IN WIRELESS SYSTEMS,” filed Apr. 25, 2005, the contents of which are incoporated by reference herein.

### BACKGROUND OF THE INVENTION

The invention relates to wireless communication networks, and, more particularly, to scheduling of packet data services in wireless communication networks.

The Transmission Control Protocol (TCP) is the dominant transport layer protocol on the Internet. Although TCP has proven itself as excellently scalable and particularly robust to the unpredictable dynamics inside a wired network, TCP over wireless networks raises numerous performance issues. Third-generation (3G) and beyond wireless communication system architectures which provide high-speed packet data services-such as CDMA2000 1×EV High Data Rate (HDR) or WCDMA High Speed Data Packet Access (HSDPA)-include advanced techniques such as local retransmission schemes to lessen the impact of wireless link losses on TCP-layer performance. See, e.g., P. Bender, et al., “CDMA/HDR: a Bandwidth Efficient High Speed Wireless Data Service for Nomadic Users,” IEEE Communications Magazine, pp. 70-77 (July 2000); Third Generation Partnership Project (3GPP), 3GPP Technical Specification 25.308 version 5.2.0, “High Speed Downlink Packet Access (HSDPA): Overall description,” (March 2002).

One area for improvement, however, is in how base stations handle heterogeneous services. For example, the current base station design for cellular packet data access in HDR systems does not differentiate TCP users of different services such as TELNET, FTP, and HTTP—each of which present different user expectations with regard to delay tolerance and perceptions of system responsiveness. HDR or equivalent systems use a MAC-layer scheduler, typically a proportional fairness (PF) scheduler, as depicted in FIG. 1. Note that the opportunistic scheduler considers channel feedback but is blind to TCP traffic information. The opportunistic scheduler disadvantageously assumes an infinite backlog for each user at the base station and assigns only one FIFO queue per user for all incoming TCP flows. Such a scheduler design, being blind to TCP's heuristic flow control mechanism, may suffer from efficiency losses, such as lower aggregate throughput than expected by users. More advanced scheduler designs, such as class-based queuing (CBQ), unfortunately, are not suitable for wireless networks due to a lack of channel awareness. See S. Floyd and V. Jacobson, “Link-sharing and Resource Management Models for Packet Networks,” IEEE/ACM Trans. on Networking, pp. 365-89 (August 1995). Recently, a scheduler has been devised for wireless networks which utilizes per-flow management and imposes strict-priority scheduling at the intra-user level based on flow length. See M. C. Chan and R. Ramjee, “Improving TCP/IP Performance over Third Generation Wireless Networks: TCP/IP Performance over 3G Wireless Links with Rate and Delay Variation,” IEEE INFOCOM, Joint Conference of IEEE Computer and Communications Societies, vol. 3, pp. 1893-1904 (Mar. 2004). Unfortunately, per-flow management is costly, especially in the face of high-mobility users with frequent handoffs. Moreover, the flow length based SP-scheduler may cause out-of-order TCP packet delivery with flow re-classification.

Accordingly, there is a need for a new base station design with a service-aware scheduler which supports a high-speed downlink packet channel while providing better service quality to users of different packet data services.

### SUMMARY OF INVENTION

A base station design for a wireless communication system is herein disclosed with a new scheduler for packet data services which is advantageously both traffic-aware and channel-dependent in a manner which enhances the users' perception of network performance. In one embodiment, a cross-layer hierarchical scheduler is disclosed which further comprises an intra-user scheduler and an inter-user scheduler. The intra-user scheduler prioritizes at the network layer and maintains separate buffers for different service categories for each user in order to differentiate the service categories. The inter-user scheduler prioritizes at the media access control layer, scheduling the dequeued packets from multiple users by considering their service category information as well as each user's channel status. Both the inter-user scheduler and the intra-user scheduler preferably consider historical information to maintain resource fairness and avoid starvation of certain service categories or users. The hierarchical scheduler advantageously manages buffer and channel resources with properly differentiated service priority, and can notably speed up time-critical interactive services (e.g., such as HTTP and TELNET) with only a negligible degradation in the performance perception by bulk file downloading services (e.g., such as FTP). The hierarchical scheduler thereby considers and balances both the independent channel fluctuation of different users and the service responsiveness of heterogeneous service classifications.

The base station design disclosed herein advantageously avoids the need for any changes to end-user protocols and avoids per-flow maintenance at the base station. The scheduler schemes disclosed herein facilitate a scalable and low-cost performance enhancement over existing cellular packet data systems. These and other advantages of the invention will be apparent to those of ordinary skill in the art by reference to the following detailed description and the accompanying drawings.

### BRIEF DESCRIPTION OF DRAWINGS

FIG. 1 is a prior art base station design with a prior art opportunistic scheduler.

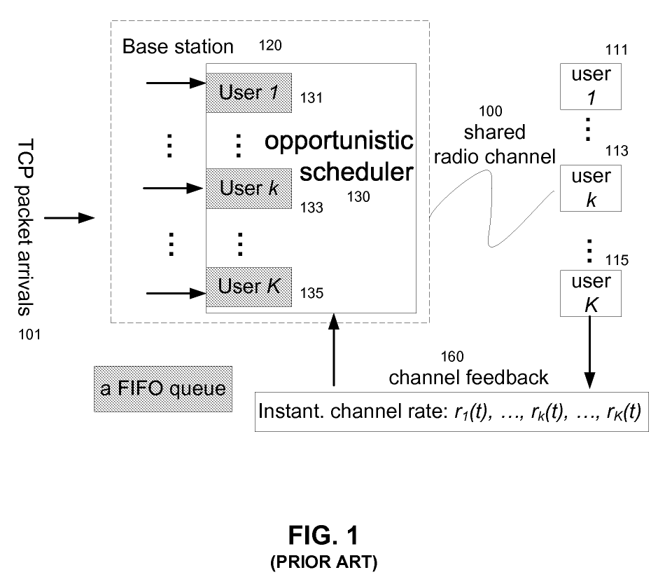

FIG. 2 depicts a base station design with a hierarchical scheduler, arranged in accordance with an embodiment of an aspect of the invention.

### DETAILED DESCRIPTION

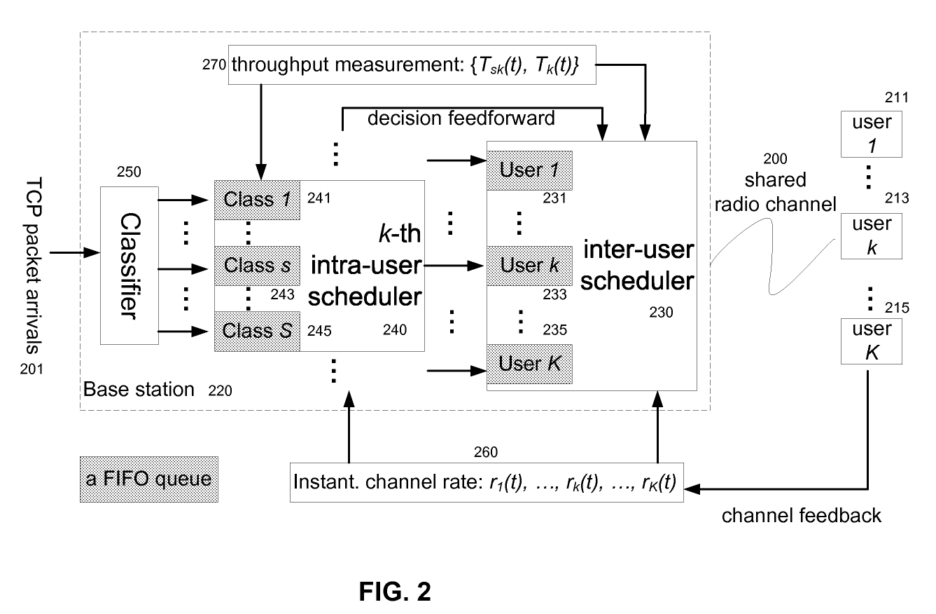

FIG. 2 shows a new base station design, in accordance with an embodiment of an aspect of the invention.

The base station 220 provides packet data services to packet data users 211, . . . , 213, . . . , 215 across a time-slotted shared wireless communication channel 200. For example, the system framework, illustratively, can be a third-generation (3G) cellular radio access network (RAN) where a time-slotted shared downlink channel supports high-speed packet data access for multiple users, e.g., a WCDMA High-Speed Downlink Packet Access (HSDPA) system (see 3gpp Technical Specification 25,308 version 5.2.0, “High Speed Downlink Packet Access (HSDPA): Overall Description,” (March 2002), which is incorporated by reference herein). For discussion purposes only and without limitation, the description herein focuses on time-division-multiplexing (TDM) based access of the shared channel 200 within a single cell, where multiple end users 211, . . . 215 at different locations wait for their turn to be scheduled for transmission by the base station 220.

The different users 211, . . . , 213, . . . , 215 may start different types of packet data services and may start multiple types of packet data services at the same time, each service having different service expectations in terms of responsiveness or transmission delay. For example, consider various different TCP-based services such as TELNET, HTTP, and FTP. TCP services are typically elastic services. FTP sessions, for example, are bulk transfers which are typically the most delay-tolerant and insensitive to short-term rate and delay variations. TEL-NET and HTTP sessions, on the other hand, tend to be more time-critical with users expecting a fast response, in spite of a certain delay tolerance. Roughly speaking, the flow's size and the delay tolerance increases from TELNET to HTTP to FTP, while the throughput expectation by perception decreases. Modern implementations of TCP include what is referred to in the art as “slow start,” in which a sender limits the rate at which packets are injected into the network to a congestion window (cwnd); the congestion window is initially of a small size and is increased only as acknowledgments are received from the recipient of the packets. See, e.g., M. Allman et al., “TCP Congestion Control,” Internet Engineering Task Force (IETF), Request for Comments (RFC) 2581 (April 1999); W. Stevens, “TCP Slow Start, Congestion Avoidance, Fast Retransmit, and Fast Recovery Algorithms,” IETF, RFC 2001 (January 1997). Unfortunately, where upper-layer protocols such as HTTP or TELNET generate data packets only intermittently, a TCP slow start may cause what appears to be intermittent connectivity in the perception of TCP users. A typical trace of web browsing packets generated during an HTTP session would show sporadic data packets with “packet calls” interleaved with “reading time” during which no data is generated. Given typical TCP settings, the TCP congestion window may reset during the reading time, thereby forcing the next packet call to start with a TCP slow start. In fact, the TCP slow start may account for a large portion of the whole transmission period, especially given the typically small size of objects downloaded during TCP, TELNET, or some HTTP sessions.

Moreover, consider the situation in which coexistent TELNET, HTTP, and FTP flows compete for a bottlenecked channel and a FIFO buffer—as in existing cellular packet data systems. It is known that TELNET or most HTTP sessions typically generate short-lived TCP flows, referred to as a series of “mice”, while FTP sessions typically generate long-lived FTP bulk downloads, i.e. a series of “elephants.” It is known that the “mice” would suffer from throughput loss—their first several packets during the slow-start period would see serious delay or losses due to the head-of-line (HOL) blocking from the heavy FTP backlog. Such systems appear to favor FTP services more than the time-critical TELNET and HTTP services, a phenomenon called “service-oriented unfairness.”

It would be advantageous for the scheduler to optimize the user's perception while simultaneously maintaining high system efficiency. The impact on users' perception of system responsiveness can be characterized by metrics such as the “normalized download completion time” (t_{d}/f) of their objects or the “goodput” (f/t_{d}) where ∫ is the size of the downloaded object and where t_{d} is the download time. On the other hand, what matters to users of services such as FTP is typically the “service continuation” specified by whether the mean goodput of each downloading is larger than a minimum rate requirement, i.e., f/t_{d}≧m.

Accordingly, the base station 220 advantageously utilizes a cross-layer hierarchical scheduler, the structure and operation of which is further described herein. As depicted in FIG. 2, a packet 201 arrives and is provided to a classifier 250. The packet 201 illustratively conforms to the TCP/IP protocol suite and is assumed to be associated with a TCP connection between one of the plurality of users 211, . . . 213, . . . 215 and a remote server. See, e.g., J. Postel, “Transmission Control Protocol,” IETF RFC 793 (September 1981). The connection is assumed to be associated with one of a plurality of application layer services, such as TELNET, HTTP, FTP, etc., which can be identified by the classifier 250. The classifier 250 can differentiate between the different services, for example, by following TCP port number conventions or by some other finer-grained mechanism such as a Differentiated Services (DiffServ) codepoint. See, e.g., S. Blake et al., “An Architecture for Differentiated Services,” IETF RFC 2475 (December 1998). An assured forwarding (AF) per-hop behavior (PHB) group, for example, can be defined with different labels corresponding to TELNET, HTTP, and FTP flows, respectively. See J. Heinanen et al., “Assured Forwarding PHB Group,” IETF Request for Comments (RFC) 2597 (June 1999).

The packets are prioritized by a hierarchical scheduler which, in the embodiment depicted in FIG. 2, comprises an intra-user scheduler 240 and an inter-user scheduler 230. The intra-user scheduler 240 acts at a higher layer than the inter-user scheduler 230, e.g., at the Internet Protocol layer, and organizes and differentiates the incoming packets based on the service classifications per user. In the embodiment depicted in FIG. 2, the intra-user scheduler 240 establishes a separate queue 241, . . . 243, . . . 245 for each service classification per user and prioritizes the packets by applying some form of weighted fair priority scheduling of the heterogeneous TCP classes for each user 211, . . . 213, . . . , 215. The inter-user scheduler 230, on the other hand, prioritizes each user 211, . . . 213, . . . , 215 at the media access control layer. In the embodiment depicted in FIG. 2, the inter-user scheduler 230 establishes a separate queue 231, . . . 233, . . . 235 for each user and provides weighted fair channel access for the multiple users 211, . . . 213, . . . , 215 over the wireless channel 200. The inter-user scheduler 230 can take advantage of known channel-dependent scheduling schemes, such as a proportional fairness scheduler—or can use a more advanced scheduler such as the design disclosed in co-pending commonly-assigned U.S. Non-Provisional patent application Ser. No. 10/731,962, entitled “SCHEDULING METHOD WITH TUNABLE THROUGHPUT MAXIMIZATION AND FAIRNESS GUARANTEES IN RESOURCE ALLOCATION,” filed on Dec. 10, 2003, the contents of which are incorporated by reference herein. The inter-user scheduler 230, however, unlike such prior art scheduling schemes, takes the results of the intra-user scheduler 240 into account when prioritizing channel access. For example, the inter-user scheduler 230 can apply service class-enforcing weights to enable service classification awareness across multiple users. Note that both the intra-user scheduler 240 and inter-user scheduler 230 consider the online measured historical throughput from module 270 in FIG. 2 to maintain fairness and avoid starvation, as further discussed below.

The operation of the hierarchical scheduler can be described formally as follows. Suppose there are K users of mobile stations. Each user has one or more TCP types of class ID s−1,2, . . . , S marked into each arriving packet. Each class s is assigned a service weight wₛ>0, and each user also has a weight Wₖ>0. A higher weight can reflect a smaller delay tolerance or more resource expectations. Each user k imposes a minimum rate (minRate) requirement: f_{ds}/t_{d}(fₖₛ)≧mₖ, where the subscript k and s denotes user ID and class ID, respectively, fₖₛ denotes the object size for the TCP type s of user k, t_{d} denotes its downloading time as a function of ∫ₖₛ, and mₖ is k's minRate requirement. Note that although only the per-user minRate is considered here, the arrangement can be naturally generalized to situations where the minRate varies per user k, per class s, or per flow.

The mean throughput per (user, class) pair or per user can be represented as a sliding-window moving average:

$${T}_{ks} ( t + 1 ) {=}^{Δ} ( 1 - \frac{t}{{t}_{s}} ) {T}_{ks} ( t ) + \frac{1}{{t}_{s}} {r}_{k} ( t ) {I}_{s}^{k} ( t ) {I}_{k} ( t ) , \\ {T}_{k} ( t + 1 ) {=}^{Δ} ( 1 - \frac{t}{{t}_{l}} ) {T}_{k} ( t ) + \frac{1}{{t}_{l}} {r}_{k} ( t ) {I}_{k} ( t ) {\sum }_{s = 1}^{S} {I}_{s}^{k} ( t ) , \qquad ( 1 )$$

where rₖ(t) is user k's instantaneous channel rate, tₛ and tₗ are the filtering interval (it should be noted that other measurement techniques could also be used). A smaller interval implies a smaller delay in response to channel fluctuations but a less accurate measurement. Normally the values of tₛ and tₗ are 1000 slots (between 0.5 and 2 s). Due to causality, the only available information to the base station includes channel feedback rₖ(t), and past throughput Tₖₛ(t) and Tₖ(t) (∀k, s) (see module 270 in FIG. 2).

For simplicity, it is assumed without limitation that the intra-user and inter-user schedulers pick only one (user, class) pair per channel slot, assuming the small slot provides a fine granularity (˜2 ms). In other words, at each time slot t, the layered intra- and inter-user schedulers decide the following two indicators, respectively:

$$\begin{matrix}{I}_{s}^{k} ( t ) = \{ \begin{matrix}1 , & s \text{-} th class is picked at t for specified user k , \\ 0 , & otherwise .\end{matrix} & ( 2 ) \\ {I}_{k} ( t ) = \{ \begin{matrix}1 , & k \text{-} th user is picked at time \text{t} , \\ 0 , & otherwise .\end{matrix} & ( 3 )\end{matrix}$$

The above indicators are equal to 1 only when the corresponding user or class has data backlog. The product Iₛ^{k}(t)Iₖ(t)=1 specifies a unique pair (k, s). It should be readily appreciated that where a big slot size is utilized, it may be necessary for the intra-user scheduler to select more than one classes from one or even multiple users per slot, say, due to traffic insufficiency or packet-level granularity loss to fill each slot. Similarly, the inter-user scheduler may pick multiple users per slot using CDM plus TDM, as proposed in HSDPA.

The hierarchical scheduler searches for the optimal indicators slot-by-slot to maximize a utility U(·), which, as further described below, can be represented as a function of the mean throughput. In accordance with the embodiment depicted in FIG. 2, the utility maximization proceeds in two stages in a hierarchy. In the first stage, the intra-user scheduler maximizes the “per-user” utility Uₖ(·) across all classes. The intra-user scheduler serves to finds an optimal and unique Iₛ^{k}*(t)=1 for each given k. In the second stage, the inter-user scheduler maximizes the “system” utility U(·) across all users. The inter-user scheduler locates an optimal and unique solution Iₖ*(t)=1 out of all users, based on the result from the first stage:

$$\begin{matrix}Stage 1 - intra \text{-} user utility \text{:} {max}_{\{ {I}_{s}^{k} ( t ) , ∀ s \}} {\sum }_{s = 1}^{S} {w}_{s} {U}_{k} ( {T}_{ks} ( {I}_{s}^{k} ( t ) ) ) , ∀ k , \\ s . t . {\sum }_{s = 1}^{S} {I}_{s}^{k} ( t ) \leq 1 , & ( 4 ) \\ Stage 2 - int er \text{-} user utility \text{:} {max}_{\{ {I}_{k} ( t ) , {I}_{s}^{k} ( t ) by ( 4 ) , ∀ k \}} {\sum }_{k = 1}^{K} {W}_{k} [ {\sum }_{s = 1}^{S} {w}_{s} {I}_{s}^{k} ( t ) ] U ( {T}_{k} ( {I}_{k} ( t ) ) ) , \\ s . t . {\sum }_{k = 1}^{K} {I}_{k} ( t ) \leq 1. & ( 5 )\end{matrix}$$

Note in the second stage, Tₖ(t)=Σₛ₌₁^{S}Tₖₛ(t), if suppose tₛ=tₗ in equation (1). Generally speaking, the intra-user scheduler differentiates classes for each individual user k, while the inter-user scheduler differentiates users, each being an aggregation of its classes. The solution set of the first stage, {Iₛ^{k}(t)=1, ∀k}, determines the class-specific weight Wₖ[Σₛ₌₁^{S}wₛIₛ^{k}(t)](∀k) in the second stage to assist its user and class differentiation.

Consider the class-enforcing weights provided in the inter-user scheduling. It can be readily seen that this second stage of scheduling reduces to class-insensitive proportional fairness (PF) scheduling if one removes the weighting item [Σₛ₌₁^{S}wₛIₛ^{k}(t)] from equation (5) and if one assumes that all users have equal weight Wₖ. The resulting scheduler would provide inter-user resource fairness but would blur the intra-user classifications. Likewise, consider the special case where S=1 or all users have the same one class of traffic. Then, the hierarchical scheduler collapses into the second stage only, performing exactly the same as a weighted PF scheduler given per-user weight Wₖ. Consider also the situation where each user k has only one backlogged class s(k) that differs fromuserto user, i.e., s(k₁)≠s(k₂), ∀k₁≠k₂ Suppose Uₖ(·)=U(·), ∀k, then the first stage degenerates while the global system utility in the second stage reduces to Σₖ₌₁^{K}Wₖwₛ₍ₖ₎Iₛ₍ₖ₎^{k}(t)Uₖ(Tₛ₍ₖ₎(t)), the weighted summarization of per-user utility in the first stage. This further derives a double-weighted PF scheduler that considers both user channel, throughput, and class ID.

The above formulation works to maximize a utility function U(·). The utility U(·) can be defined in a number of different ways. One advantageous way is to represent the utility of elastic services is as a concave and non-decreasing function of the mean throughput. Consider the following generic utility function for all users:

$${U}_{k} ( x ) = \frac{{x}^{1 - α}}{1 - α} ,$$

where α≧0. Using such a utility function, it can be shown from the above that the intra-user scheduler would operate as follows:

$${s}^{*} ( k ) = arg {max}_{\{ ∀ s \vert {A}_{ks} ( t ) = 1 \}} \frac{{w}_{s}}{{{T}_{ks} ( t )}^{α}} , ∀ k , \qquad ( 6 )$$

where wₛ is the per-class weight and where

$${A}_{ks} ( t ) = \{ \begin{matrix}1 , & s \text{-} th class is backlogged at t for user k , \\ 0 , & otherwise .\end{matrix}$$

That is, Iₛ^{k}*(t)−1 while Iₛ^{k}(t)−0, ∀s≠s* and for each specified k. Note that the instantaneous channel rate rₖ(t) is independent of class ID. The traffic backlog, if any, is assumed sufficient to support the transmission within each slot. A TCP class after a silent period of arrivals, will see a smaller Tₖₛ(t) and will thus have a higher scheduling priority. The per-class weight wₛ may be assigned properly to differentiate the relative responsiveness of co-existing classes, e.g., w₁=2w₂=4w₃ for TELNET, HTTP, and FTP. In this way, the scheduler protects bursty or short-lived TCP flows from existing bulk flows, and thus mitigates the service-oriented unfairness. The inventors refer to this scheme as measurement-based “weighted fair priority” (wfp) scheduling.

The inter-user scheduler can be setup to prioritize users at the MAC layer according to their current channel rate rₖ(t), aggregate throughput Tₖ(t), and their optimal class ID s*(k) (being a function of k) as decided by the intra-user scheduler. Adopting the same utility function and approach as above, one can represent the operation of the inter-user scheduling as follows:

$${k}^{*} = arg {max}_{\{ ∀ k \}} {W}_{k} {w}_{{s}^{*} ( k )} \frac{{A}_{{ks}^{*} ( k )} ( t ) {r}_{k} ( t )}{{{T}_{k} ( t )}^{α}} , \qquad ( 7 )$$

that is, Iₖ*(t)−1 while Iₖ(t)−0(∀k≠k*). The inventors refer to this scheme as the “weighted fair priority aided alpha-rule” (wfpAlpha) scheduling.

It can be shown that the parameter

$$\frac{{r}_{k} ( t )}{{{T}_{k} ( t )}^{α}}$$

enables a flexible tradeoff between aggregate throughput and per-user resource fairness by tuning α. The per-class weight W_{s*(k)} enables class awareness across multiple users. The per-user weight Wₖ differentiates users, for example, by minRate guarantee if it is defined as the depth of a minRate-driven token bucket that leaks at the same pace of the service rate, as proposed in the M-LWDF scheduler. See M. Andrews et al., “Providing Quality of Service over a Shared Wireless Link,” IEEE Communications Magazine, pp. 150-54 (February 2001).

Unlike prior art scheduler designs which do not consider sporadic TCP arrivals and which do not differentiate heterogeneous TCP services, the hierarchical scheduler depicted in FIG. 2 advantageously integrates queue management and radio resource (channel) management in a manner that can optimize TCP user perception while maintaining high system efficiency. The hierarchical scheduler is advantageously both channel-dependent and traffic-aware and can be tuned to optimize TCP user perception, e.g., as specified by fairness, goodput, differentiated responsiveness, while keeping the system efficiency or aggregate throughput high at the same time. The disclosed scheduler design has a number of other advantages. For example, the design imposes no mandatory TCP protocol changes on the end-user or server side, which is advantageous for scalability and adoption. The design also does not break down the end-to-end TCP semantics at the per-flow level, thereby minimizing concerns for high complexity especially in a mobile environment. The design can be readily combined with the latest link-layer techniques, such as Adaptive Modulation and Coding (AMC) and multi-process Stop-And-Wait (SAW) HARQ.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents. As but one of many variations, it should be understood that the above discussion regarding the categorization of HTTP, TCP, and FTP services were used merely for illustration and other forms of service categorization can be readily utilized in the context of the present invention

What is claimed is:

1. A method for scheduling packets in a wireless communication system providing packet data services across a shared downlink communication channel, the method comprising the steps of:
classifying packets based on a service classification;
prioritizing the packets at an intra-user scheduler based on the service classification and on an online quality-of-service (QoS) measurement; and
prioritizing the packets at an inter-user scheduler based on results from the intra-user scheduler and based on channel conditions, as fed back by user stations in the wireless communication system, and the online QoS measurement.

2. The method of claim 1 wherein the packets are prioritized at the intra-user scheduler using weighted fair scheduling of the service classifications.

3. The method of claim 1 wherein the QoS measurement comprises a measurement of throughput.

4. The method of claim 1 wherein separate buffers are maintained by the intra-user scheduler for different service classifications for each user station.

5. The method of claim 1 wherein the packets are prioritized by the intra-user scheduler by maximizing a per-user utility across all classes.

6. The method of claim 1 wherein a separate buffer is maintained by the inter-user scheduler for each user station and wherein the packets are prioritized by the inter-user scheduler using weighted fair channel access for the users.

7. The method of claim 1 wherein the packets are prioritized by the inter-user scheduler by maximizing a system utility across all users.

8. The method of claim 7 wherein the utility is represented by a concave and non-decreasing function of a mean throughput of the network.

9. The method of claim 1 wherein the packet data services utilize the Transmission Control Protocol (TCP) and wherein the service classification is based on which TCP service is being used.

10. The method of claim 1 wherein different service classifications are specified using DiffServ.

11. A base station providing packet data services across a shared wireless downlink communication channel to one or more users, the base station comprising:
a classifier which arranges packets in the packet data services based on a plurality of service classifications;
a hierarchical scheduler further comprising an intra-user scheduler and an inter-user scheduler, the intra-user scheduler prioritizing the packets in the packet data service for each wireless station of a plurality of wireless stations based on the service classification and on a quality-of-service (QoS) measurement while the inter-user scheduler prioritizes the packets in the packet data services based on results from the intra-user scheduler and based on channel conditions, as fed back by user stations in the wireless communication system, and the QoS measurement.

12. The base station of claim 11 wherein the intra-user scheduler prioritizes the packets using weighted fair scheduling of the service classifications.

13. The base station of claim 11 wherein the QoS measurement comprises a measurement of throughput.

14. The base station of claim 11 wherein the intra-user scheduler maintains separate buffers for different service classifications for each user station.

15. The base station of claim 11 wherein the intra-user scheduler prioritizes the packets by maximizing a per-user utility across all classes.

16. The base station of claim 11 wherein the inter-user scheduler maintains a separate buffer for each user station and wherein the inter-user scheduler prioritizes the packets using weighted fair channel access for the users.

17. The base station of claim 11 wherein the inter-user scheduler prioritizes the packets by maximizing a system utility across all users.

18. The base station of claim 17 wherein the utility is represented by a concave and non-decreasing function of a mean throughput of the network.

19. A method for scheduling packets in a wireless communication system providing packet data services across a shared downlink communication channel, the method comprising the steps of:
classifying packets based on a service classification;
prioritizing the packets at an intra-user scheduler using weighted fair scheduling of the service classifications and based at least in part on an online throughput measurement; and
prioritizing the packets at an inter-user scheduler based on results from the intra-user scheduler and based on channel conditions as measured by the throughput measurement.

20. The method of claim 19 wherein the packets are prioritized by the inter-user scheduler using weighted fair channel access for the users.
